(19) United States
(12) Patent Application Publication
(10) Pub. No.: US 2014/0247286 A1
(43) Pub. Date: Sep. 4, 2014

(54) Active Stabilization for Heads-Up Displays

(71) Applicant: Liang-Yu (Tom) Chi, San Francisco, CA (US)

(72) Inventor: Liang-Yu (Tom) Chi, San Francisco, CA (US)

(73) Assignee: GOOGLE INC., Mountain View, CA (US)

(21) Appl. No.: 13/400,230

(22) Filed: Feb. 20, 2012

(51) Int. Cl. G09G 5/00

(52) U.S. Cl. 345/672; 345/8

(57) ABSTRACT

Methods and systems for active stabilization for heads-up displays are described. A wearable computing device may include a head-mounted display (HMD) with an eye-tracking system. The wearable computing device may generate a display of content at a given location in a display area of the HMD. A user may be wearing the HMD and may be subjected to mechanical jostling resulting in a movement of the HMD with respect to a gaze axis of an eye of the user. The wearable computing device may receive information relating to the gaze axis from the eye-tracking system and may receive information relating to the movement of the HMD from sensors coupled to the HMD. The wearable computing device may adjust the given location of the displayed content in the display area to compensate for such movement. The content may thus appear stable to the user.

### BACKGROUND

Wearable computers include electronic devices that may be worn by a user. As examples, wearable computers can be under or on top of clothing or integrated into eye glasses. There may be constant interaction between a wearable computer and a user. The wearable computer may be integrated into user activities and may be considered an extension of the mind and/or body of the user.

The wearable computer may include an image display element close enough to an eye of a wearer such that a displayed image fills or nearly fills a field of view associated with the eye, and appears as a normal sized image, such as might be displayed on a traditional image display device. The relevant technology may be referred to as “near-eye displays.” Near-eye displays may be integrated into wearable displays, also sometimes called “head-mounted displays” (HMDs).

### SUMMARY

The present application discloses embodiments that relate to active stabilization for head-mounted displays. In one aspect, the present application describes a method. The method may comprise causing content to be displayed at a given location in a display area of a head-mounted display (HMD). The method may also comprise receiving movement information relating to movement of the HMD and receiving gaze information relating to a gaze axis from an eye-tracking system coupled to the HMD. The method may further comprise adjusting the given location of the displayed content in the display area, based on the movement information and the gaze information.

In another aspect, the present application describes a computer readable memory having stored thereon instructions executable by a computing device to cause the computing device to perform functions. The functions may comprise receiving information relating to a first position of a head-mounted display (HMD) coupled to a wearable computing system. The functions may also comprise receiving, from an eye-tracking system coupled to the wearable computing system, gaze information relating to a gaze axis. The functions may further comprise causing content to be displayed at a given location in a display area of the HMD, based on a first relative position of the HMD with respect to the gaze axis of the eye. The functions may also comprise receiving information relating to a movement of the HMD to a second position. The functions may further comprise adjusting the given location of the displayed content in the display area, based on a second relative position of the HMD with respect to the gaze axis.

In still another aspect, the present application describes a system. The system may comprise a head-mounted display (HMD). The system may also comprise an eye-tracking system configured to provide gaze information relating to a gaze axis. The system may further comprise a computing device in communication with the HMD and the eye-tracking system. The computing device may be configured to cause content to be displayed at a given location in a display area of the HMD. The computing device may also be configured to receive movement information relating to movement of the HMD and receive the gaze information relating to the gaze axis from the eye-tracking system. The computing device may further be configured to adjust the given location of the displayed content in the display area, based on the movement information and the gaze information.

The foregoing summary is illustrative only and is not intended to be in any way limiting. In addition to the illustrative aspects, embodiments, and features described above, further aspects, embodiments, and features will become apparent by reference to the figures and the following detailed description.

### BRIEF DESCRIPTION OF THE FIGURES

FIG. 1 is a block diagram of an example wearable computing and head-mounted display system, in accordance with an example embodiment.

FIG. 2A illustrates a front view of a head-mounted display (HMD) in an example eyeglasses embodiment that includes a head-mounted support, in accordance with an example embodiment.

FIG. 2B illustrates a side view of the HMD of FIG. 2A.

FIG. 3 is a flow chart of a method for active stabilization of a displayed content on the HMD, in accordance with an example embodiment.

FIGS. 4A-4C illustrate stabilizing a display due to a shift in the HMD, in accordance with an example embodiment.

FIGS. 5A-5C illustrate stabilizing a display due to a rotation of the HMD, in accordance with an example embodiment.

FIGS. 6A-6F illustrate stabilizing a display due to a change in a viewing distance, in accordance with an example embodiment.

FIG. 7 is a functional block diagram illustrating a computing device, in accordance with an example embodiment.

FIG. 8 is a schematic illustrating a conceptual partial view of a computer program, in accordance with an example embodiment.

### DETAILED DESCRIPTION

The following detailed description describes various features and functions of the disclosed systems and methods with reference to the accompanying figures. In the figures, similar symbols identify similar components, unless context dictates otherwise. The illustrative system and method embodiments described herein are not meant to be limiting. It may be readily understood that certain aspects of the disclosed systems and methods can be arranged and combined in a wide variety of different configurations, all of which are contemplated herein.

A wearable computing device may include a head-mounted display (HMD) and an eye-tracking system. The wearable computing device may be configured to generate a display of content at a given location in a display area (e.g., a window) of the HMD. A user may be wearing the wearable computing device and may be moving or may be subjected to mechanical jostling resulting in a movement of the HMD with respect to a gaze axis of an eye of the user. The wearable computing device may be configured to receive information relating to the gaze axis of the eye from the eye-tracking system and may be configured to receive information relating to the movement of the HMD from one or more sensors coupled to the HMD (e.g., accelerometer, gyroscope, magnetometer, etc.) and may accordingly adjust the given location of the displayed content in the display area to compensate for such movement. The content may thus appear stable to the user.

As an example, based on the information relating to the gaze axis and the information relating to the movement of the wearable computing device, the wearable computing device may be configured to apply a transform to the displayed content to compensate for the movement of the HMD. The transform may, for example, include an offset to compensate for a shift of the HMD with respect to the gaze axis. The transform may also comprise a rotational adjustment to compensate for a rotation of the HMD with respect to the gaze axis. The transform may further comprise a scale factor that may compensate for a change in a distance between the eye of the user and a reference point on the HMD due to the HMD moving farther or closer to the eye. By applying the transform to the displayed content, the content displayed in the display area may appear stable and fixed with respect to the eye of the user.

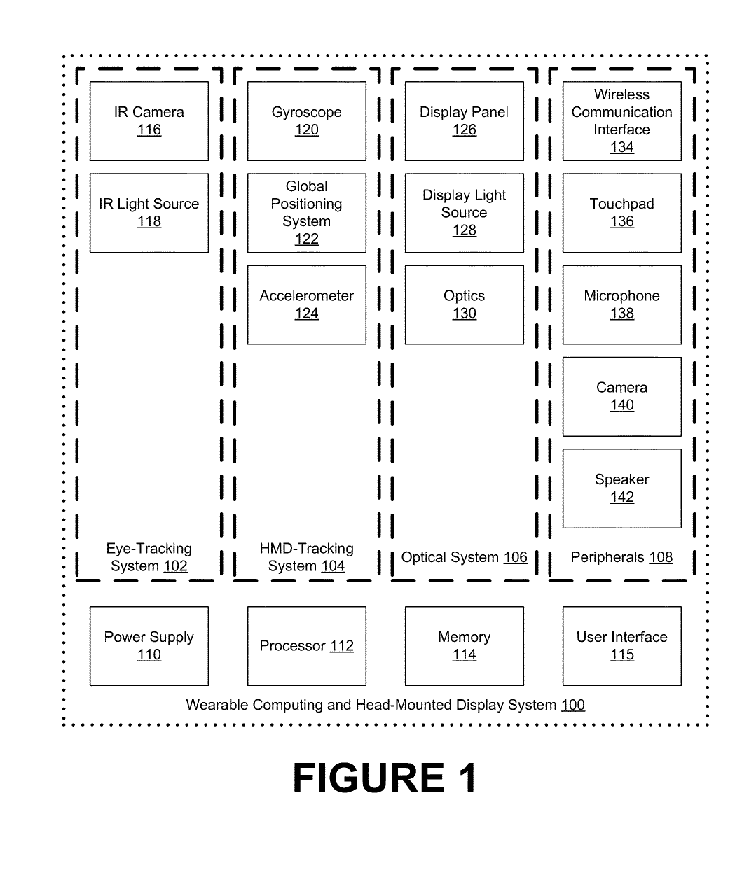

Referring now to the Figures, FIG. 1 is a block diagram of an example wearable computing and head-mounted display (HMD) system 100 that may include several different components and subsystems. Components coupled to or included in the system 100 may include an eye-tracking system 102, a HMD-tracking system 104, an optical system 106, peripherals 108, a power supply 110, a processor 112, a memory 114, and a user interface 115. Components of the system 100 may be configured to work in an interconnected fashion with each other and/or with other components coupled to respective systems. For example, the power supply 110 may provide power to all the components of the system 100. The processor 112 may receive information from and control the eye-tracking system 102, the HMD-tracking system 104, the optical system 106, and peripherals 108. The processor 112 may be configured to execute program instructions stored in the memory 114 and to generate a display of images on the user interface 115.

The eye-tracking system 102 may include hardware such as an infrared camera 116 and at least one infrared light source 118. The infrared camera 116 may be utilized by the eye-tracking system 102 to capture images of an eye of the wearer. The images may include either video images or still images or both. The images obtained by the infrared camera 116 regarding the eye of the wearer may help determine where the wearer may be looking within a field of view of the HMD included in the system 100, for instance, by ascertaining a location of an eye pupil of the wearer. The infrared camera 116 may include a visible light camera with sensing capabilities in the infrared wavelengths.

The infrared light source 118 may include one or more infrared light-emitting diodes or infrared laser diodes that may illuminate a viewing location, i.e. an eye of the wearer. Thus, one or both eyes of a wearer of the system 100 may be illuminated by the infrared light source 118. The infrared light source 118 may be positioned along an optical axis common to the infrared camera, and/or the infrared light source 118 may be positioned elsewhere. The infrared light source 118 may illuminate the viewing location continuously or may be turned on at particular times.

The HMD-tracking system 104 may include a gyroscope 120, a global positioning system (GPS) unit 122, and an accelerometer 124. The HMD-tracking system 104 may be configured to provide information associated with a position and an orientation of the HMD to the processor 112. This position and orientation data may help determine a reference axis to which a gaze axis may be compared, for example. The gyroscope 120 may include a microelectromechanical system (MEMS) gyroscope or a fiber optic gyroscope as examples. The gyroscope 120 may be configured to provide orientation information to the processor 112. The GPS unit 122 may include a receiver that obtains clock and other signals from GPS satellites and may be configured to provide real-time location information to the processor 112. The HMD-tracking system 104 may further include an accelerometer 124 configured to provide motion input data to the processor 112.

The optical system 106 may include components configured to provide images to a viewing location, i.e. an eye of the wearer. The components may include a display panel 126, a display light source 128, and optics 130. These components may be optically and/or electrically-coupled to one another and may be configured to provide viewable images at a viewing location. One or two optical systems 106 may be provided in the system 100. In other words, the HMD wearer may view images in one or both eyes, as provided by one or more optical systems 106. Also, the optical system(s) 106 may include an opaque display and/or a see-through display coupled to the display panel 126, which may allow a view of the real-world environment while providing superimposed virtual images. The infrared camera 116 coupled to the eye-tracking system 102 may be integrated into the optical system 106.

Additionally, the system 100 may include or be coupled to peripherals 108, such as a wireless communication interface 134, a touchpad 136, a microphone 138, a camera 140, and a speaker 142. Wireless communication interface 134 may use 3G cellular communication, such as CDMA, EVDO, GSM/GPRS, or 4G cellular communication, such as WiMAX or LTE. Alternatively, wireless communication interface 134 may communicate with a wireless local area network (WLAN), for example, using WiFi. In some examples, wireless communication interface 134 may communicate directly with a device, for example, using an infrared link, Bluetooth, near field communication, or ZigBee.

The power supply 110 may provide power to various components in the system 100 and may include, for example, a rechargeable lithium-ion battery. Various other power supply materials and types known in the art are possible.

The processor 112 may execute instructions stored in a non-transitory computer readable medium, such as the memory 114, to control functions of the system 100. Thus, the processor 112 in combination with instructions stored in the memory 114 may function as a controller of system 100. For example, the processor 112 may control the wireless communication interface 134 and various other components of the system 100. In other examples, the processor 112 may include a plurality of computing devices that may serve to control individual components or subsystems of the system 100. Analysis of the images obtained by the infrared camera 116 may be performed by the processor 112 in conjunction with the memory 114.

In addition to instructions that may be executed by the processor 112, the memory 114 may store data that may include a set of calibrated wearer eye pupil positions and a collection of past eye pupil positions. Thus, the memory 114 may function as a database of information related to gaze direction. Calibrated wearer eye pupil positions may include, for instance, information regarding extents or range of an eye pupil movement (right/left and upwards/downwards), and relative position of eyes of the wearer with respect to the HMD. For example, a relative position of a center and corners of an HMD screen with respect to a gaze direction or a gaze angle of the eye pupil of the wearer may be stored. Also, locations or coordinates of starting and ending points, or waypoints, of a path of a moving object displayed on the HMD, or of a static path (e.g., semicircle, Z-shape etc.) may be stored on the memory 114.

The system 100 may further include the user interface 115 for providing information to the wearer or receiving input from the wearer. The user interface 115 may be associated with, for example, displayed images, a touchpad, a keypad, buttons, a microphone, and/or other peripheral input devices. The processor 112 may control functions of the system 100 based on input received through the user interface 115. For example, the processor 112 may utilize user input from the user interface 115 to control how the system 100 may display images within a field of view or may determine what images the system 100 may display.

As described above, components of the HMD 100 may be configured to work in an interconnected fashion with other components within or outside their respective systems. For instance, the infrared camera 116 may image one or both of eyes of a wearer of the HMD 100 and may deliver image information to the processor 112, which may access the memory 112 and make a determination regarding the direction of a gaze of the wearer, also termed a gaze axis.

The gaze axis may be defined as an axis extending from a viewing location (e.g., an eye) and through a gaze point located within a field of view of the wearer. One way to determine a gaze axis of a person may include ascertaining a position of an eye pupil with respect to a reference point. To track eye pupil movements, infrared light may be reflected off of the eye. The reflected light may be collected and detected with an infrared detector. Upon imaging of the eye, image processing can be conducted with a processor 112 in order to determine, for instance, extents and centroid location of the eye pupil. Other known means and methods of eye-tracking may include use of visible light illumination and/or various imaging techniques.

The processor 112 may further accept input from the GPS unit 122, the gyroscope 120, and/or the accelerometer 124 to determine the location and orientation of the HMD 100. Subsequently, the processor 112 may control the user interface 115 and the display panel 126 to display virtual images to the wearer of HMD 100 that may include context-specific information based on location and orientation of the HMD 100 as well as gaze axis of the wearer of the HMD 100.

Although FIG. 1 shows various components of the system 100 (i.e., wireless communication interface 134, processor 112, memory 114, infrared camera 116, display panel 126, GPS 122, and user interface 115) as being integrated into the system 100, one or more of the described functions or components of the system 100 may be divided up into additional functional or physical components, or combined into fewer functional or physical components. For example, the infrared camera 116 may be mounted on the wearer separate from the system 100. Thus, the system 100 may be part of a wearable computing device in the form of separate devices that can be worn on or carried by the wearer. Separate components that make up the wearable computing device may be communicatively coupled together in either a wired or wireless fashion. In some further examples, additional functional and/or physical components may be added to the examples illustrated by FIG. 1. In other examples, the system 100 may be included within other systems.

The system 100 may be configured as, for example, eyeglasses, goggles, a helmet, a hat, a visor, a headband, or in some other form that can be supported on or from a head of the wearer. The system 100 may be further configured to display images to both eyes of the wearer. Alternatively, the system 100 may display images to only one eye, either a left eye or a right eye.

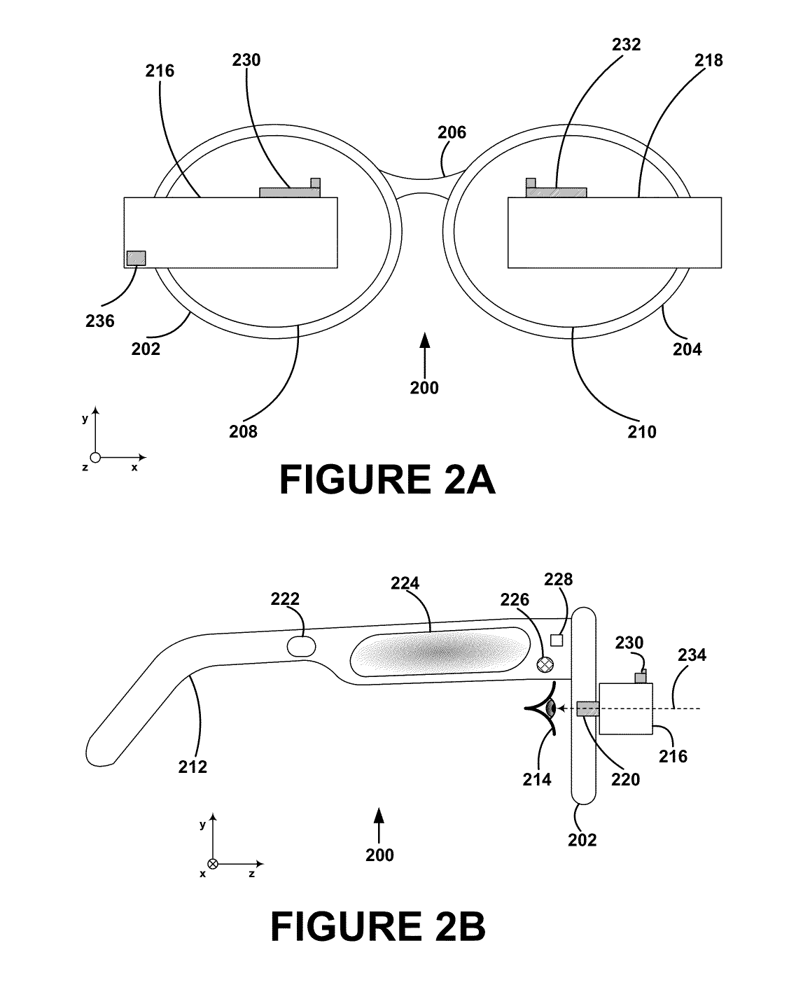

FIG. 2A illustrates a front view of a head-mounted display (HMD) 200 in an example eyeglasses embodiment. FIG. 2B presents a side view of the HMD 200 in FIG. 2A. FIGS. 2A and 2B will be described together. Although this example embodiment is provided in an eyeglasses format, it will be understood that wearable systems and HMDs may take other forms, such as hats, goggles, masks, headbands and helmets. The HMD 200 may include lens frames 202 and 204, a center frame support 206, lens elements 208 and 210, and an extending side-arm 212 that may be affixed to the lens frame 202. There may be another extending side arm affixed to the lens frame 204 but is not shown. The center frame support 206 and side-arm 212 may be configured to secure the HMD 200 to a head of a wearer via a nose and an ear of the wearer. Each of the frame elements 202, 204, and 206 and the extending side-arm 212 may be formed of a solid structure of plastic or metal, or may be formed of a hollow structure of similar material so as to allow wiring and component interconnects to be internally routed through the HMD 200. Lens elements 208 and 210 may be at least partially transparent so as to allow the wearer to look through them. In particular, a right eye 214 of the wearer may look through right lens 210. Optical systems 216 and 218 may be positioned in front of lenses 208 and 210, respectively. The optical systems 216 and 218 may be attached to the HMD 200 using support mounts such as 220 shown for the right optical system 216. Furthermore, the optical systems 216 and 218 may be integrated partially or completely into lens elements 208 and 210, respectively.

Although FIG. 2A illustrates an optical system for each eye, the HMD 200 may include an optical system for only one eye (e.g., right eye 214). The wearer of the HMD 200 may simultaneously observe from optical systems 216 and 218 a real-world image with an overlaid displayed image. The HMD 200 may include various elements such as a processor 222, a touchpad 224, a microphone 226, and a button 228. The processor 222 may use data from, among other sources, various sensors and cameras to determine a displayed image that may be displayed to the wearer. The HMD 200 may also include eye-tracking systems 230 and 232 that may be integrated into the optical systems 216 and 218, respectively. The location of eye-tracking systems 230 and 232 is for illustration only. The eye-tracking systems 230 and 232 may be positioned in different locations and may be separate or attached to the HMD 200. A gaze axis or direction 234 associated with the eye 214 may be shifted or rotated with respect to the optical system 216 or eye-tracking system 230 depending on placement of the HMD 200 on the nose and ears of the wearer or due to motion and mechanical jostling of the HMD 200. The eye-tracking systems 230 and 232 may include hardware such as an infrared camera and at least one infrared light source, but may include other components also. In one example, an infrared light source or sources integrated into the eye-tracking system 230 may illuminate the eye 214 of the wearer, and a reflected infrared light may be collected with an infrared camera to track eye or eye-pupil movement.

The HMD 200 may include a sensor or sensor pack 236. The sensor pack 236 may include one or more of an accelerometer, a gyroscope, and a magnetometer or other such sensors. The sensor pack 236 may be configured to provide information relating to movement of the HMD 200 to the processor 222. The sensor pack 236 may, for example, provide information associated with speed and acceleration associated with movement of the HMD 200. The speed and the acceleration may be linear or rotational. The sensor pack 236 may also be configured to provide information relating to a position or a change in position of the HMD 200. The sensor pack 236 may, for example, provide information associated with incremental changes in position relative to a reference position of the HMD with respect to a given reference axis or reference point. The sensor pack 236 may also provide information relating to a viewing distance, which may be defined as a distance from an eye or an eye pupil to a reference point on the HMD 200 (e.g., a point on one of the lens 208 or 210). The sensor pack 236 is shown coupled to the optical system 216 but may be placed at other locations and/or coupled to other components or subsystems of the HMD 200. As examples, the sensor pack 236 may be coupled to or affixed to the lens frames 202 and 204, or the center frame support 206, or the lens elements 208 and 210, or the extending side-arm 212.

Those skilled in the art would understand that other user input devices, user output devices, wireless communication devices, sensors, and cameras may be reasonably included in such a wearable computing system.

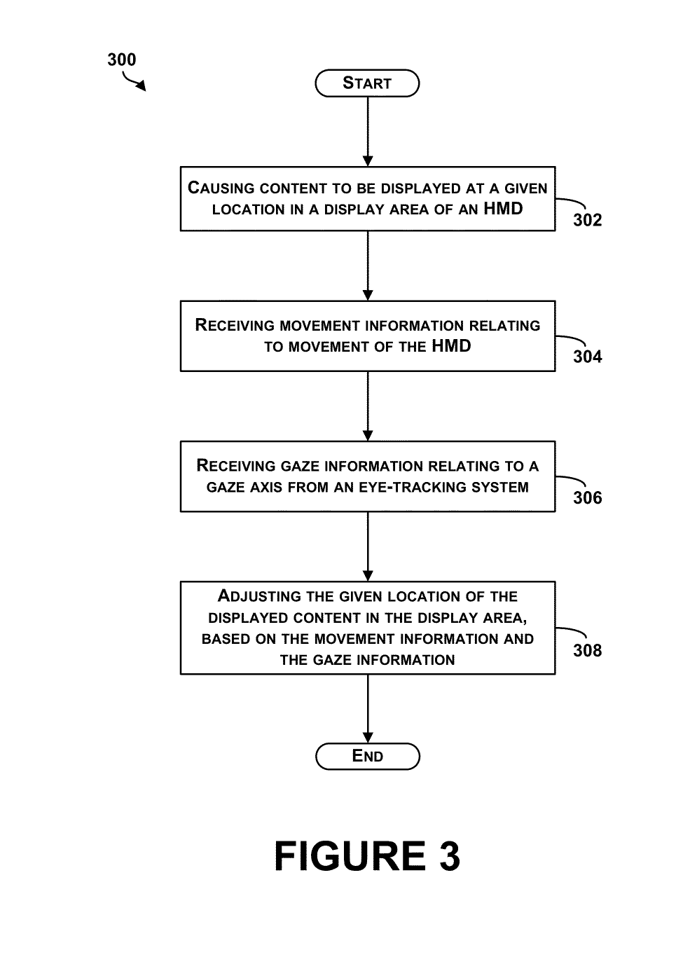

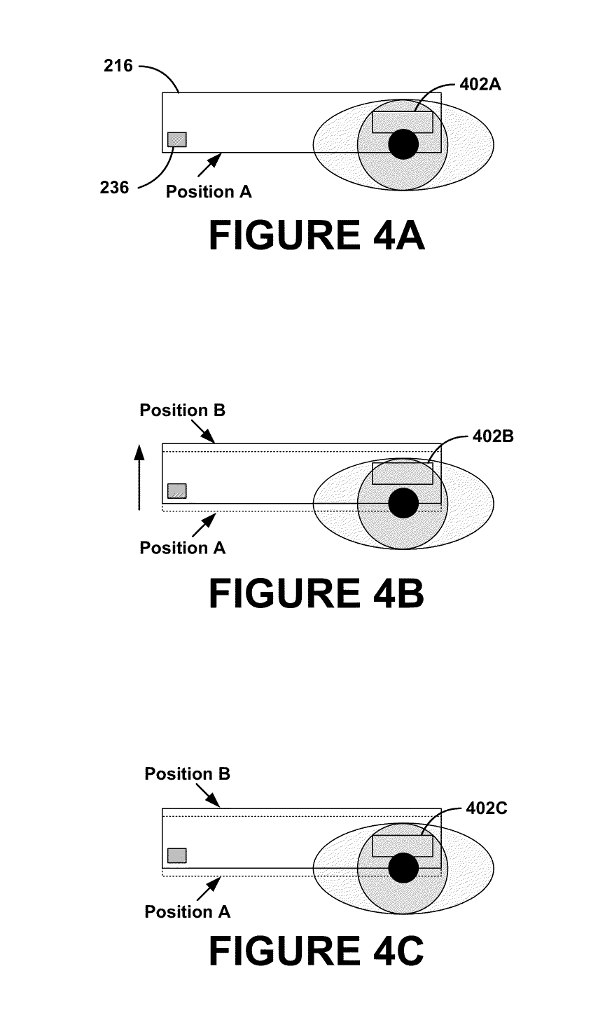

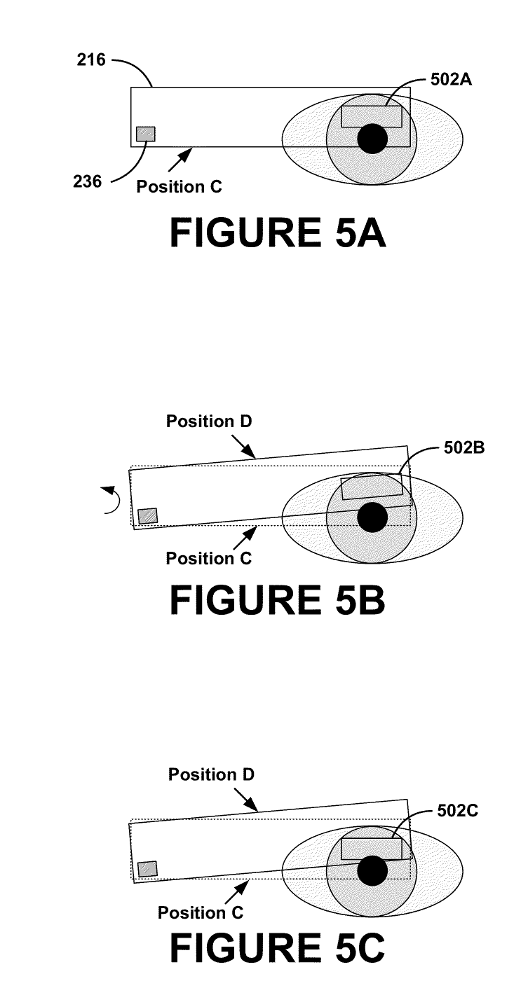

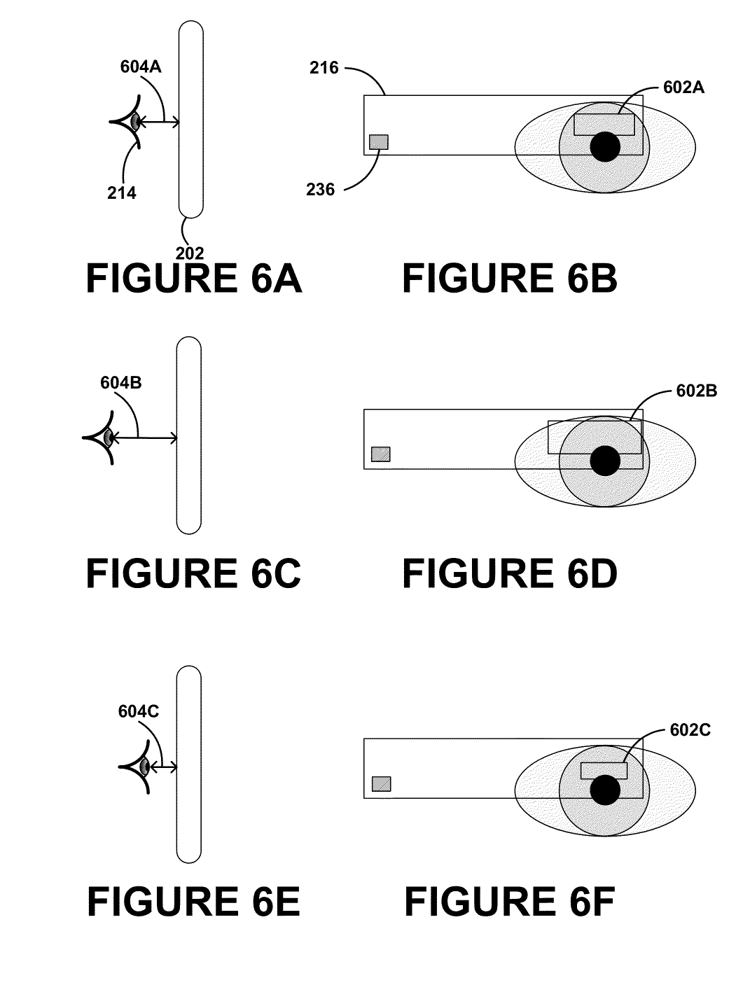

FIG. 3 is a flow chart illustrating an example method 300 for active stabilization of a displayed content on an HMD. The HMD may be coupled to a wearable computing system through wired or wireless communication. FIGS. 4A-4C illustrate an example of stabilizing a display due to a shift in the HMD to illustrate the method 300. FIGS. 5A-5C illustrate an example of stabilizing a display due to a rotation of the HMD to also illustrate the method 300. FIGS. 6A-6F illustrate an example of stabilizing a display due to a change in a viewing distance to further illustrate the method 300. FIGS. 6A, 6C, and 6E illustrate a side view of the HMD 200 illustrated in FIG. 2, while FIGS. 6B, 6D, and 6F illustrate a front view of the HMD 200. FIGS. 3, 4A-4C, 5A-5C and 6A-6F will be described together.

The method 300 may include one or more operations, functions, or actions as illustrated by one or more of blocks 302, 304, 306, and 308. Although the blocks are illustrated in a sequential order, these blocks may in some instances be performed in parallel, and/or in a different order than those described herein. Also, the various blocks may be combined into fewer blocks, divided into additional blocks, and/or removed based upon the desired implementation

In addition, for the method 300 and other processes and methods disclosed herein, the flowchart shows functionality and operation of one possible implementation of present embodiments. In this regard, each block may represent a module, a segment, or a portion of program code, which includes one or more instructions executable by a processor for implementing specific logical functions or steps in the process. The program code may be stored on any type of computer readable medium, for example, such as a storage device including a disk or hard drive. The computer readable medium may include a non-transitory computer readable medium, for example, such as computer-readable media that stores data for short periods of time like register memory, processor cache and Random Access Memory (RAM). The computer readable medium may also include non-transitory media or memory, such as secondary or persistent long term storage, like read only memory (ROM), optical or magnetic disks, compact-disc read only memory (CD-ROM), for example. The computer readable media may also be any other volatile or non-volatile storage systems. The computer readable medium may be considered a computer readable storage medium, a tangible storage device, or other article of manufacture, for example.

In addition, for the method 300 and other processes and methods disclosed herein, each block in FIG. 3 may represent circuitry that is wired to perform the specific logical functions in the process.

At block 302, the method 300 includes causing content to be displayed at a given location in a display area of an HMD. The HMD may enable its wearer to observe real-world surroundings of a wearer and also view displayed content, such as one or more computer-generated images. In some cases, the displayed content may overlay a portion of a field of view of the wearer.

The displayed content may include, for example, graphics, text, and/or video. The displayed content may relate to any number of contexts, including but not limited to a current environment of the wearer, an activity in which the wearer may currently be engaged, biometric status of the wearer, and any audio, video, or textual communications that may have been directed to the wearer. The displayed content may also include menus, selection boxes, navigation icons, or other user interface features that may enable the wearer to invoke functions of and interact with the HMD.

The displayed content by the HMD may appear anywhere in the field of view of the wearer. For example, the displayed content may occur at or near a center of the field of view, or the may be confined to a top, a bottom, or a corner of the field of view. In addition, the displayed content may overlay only a small portion (e.g., a window) of the field of view of the wearer.

FIGS. 4A-4C, 5A-5C, and 6A-6F illustrate a portion of the right side of the HMD 200 including the optical system 216 for illustration. However, the method 300 may apply to both left and right sides.

In FIG. 4A a computing device coupled to and in communication with the wearable computing system and the HMD 200 may be configured to generate a displayed content 402A at a given location in a display area of the optical system 216, for example. The HMD 200 is shown at a given position A. Similarly, in FIG. 5A, the computing device may be configured to generate a displayed content 502A at a given location in a display area of the optical system 216, for example. The HMD 200 is shown at a given position C. Also, in FIG. 6B, the computing device may be configured to generate a displayed content 602A at a given location in a display area of the optical system 216, for example. The computing device may be configured to generate the display at the given location based on a relative position of the HMD 200 with respect to a gaze axis.

At block 304, the method 300 includes receiving movement information relating to movement of the HMD. For example, in FIGS. 4A-4C, 5A-5C, and 6A-6F the computing device may be configured to receive from the sensor pack 236 information relating to the movement of the HMD 200. The wearer of the HMD 200 may, for instance, be walking or running or riding in a car and thus may be moving. The HMD 200 may accordingly be subjected to mechanical jostling and may move or be displaced with respect to a given reference position. The movement information may include, for example, information relating to a modified position of the HMD 200, speed of the movement of the HMD 200, and acceleration of the movement of the HMD 200. The movement information may include information relating to linear speed and linear acceleration of the movement of the HMD 200, and/or rotational speed and rotational acceleration of the HMD 200. The movement information may include information associated with the movement of the HMD 200 from a first position to a second position, information associated with rate of motion between the first position and second position (speed, acceleration, etc.), information associated with and a relative position of the HMD 200 at the second position with respect to the gaze axis.

FIG. 4B illustrates the HMD 200 moving to a position B that is shifted upwards with respect to position A as an example. Other positions are possible. The displayed content corresponding to position B of the HMD 200 may be shifted upwards with the HMD with respect to an eye or a gaze axis as shown by displayed content 402B assuming no adjustments to the given location of the displayed content. The sensor pack 236 may provide information relating to position B, relative position of the HMD 200 at position B with respect to position A, and may provide information relating to linear speed and linear acceleration associated with motion of the HMD from position A to position B.

FIG. 5B illustrates the HMD 200 moving to a position D that is rotated counter-clockwise with respect to position C as an example. Other positions are possible. The displayed content may be rotated counter-clockwise with the HMD 200 with respect to an eye or a gaze axis as shown by displayed content 502B assuming no adjustments to the given location of the display content. The sensor pack 236 may provide information relating to position D, relative position of the HMD 200 at position D with respect to position C, and may provide information relating to rotational speed and rotational acceleration associated with motion of the HMD 200 from position C to position D.

The sensor pack 236 and/or other sensors coupled to the wearable computing system may further be configured to provide information relating to a viewing distance, which may be defined as a distance from an eye or an eye pupil to a reference point on the HMD 200. FIG. 6A, for example, illustrates a viewing distance 604A that is a distance between the eye pupil of the eye 214 and the lens 202. FIG. 6B shows a displayed content 602A corresponding to the viewing distance 604A. In one example, the HMD 200 may move farther with respect to the eye or the eye-pupil as shown in FIG. 6C, and the sensor pack 236 and/or other sensors coupled to the wearable computing system may be configured to provide information relating to a change in the viewing distance to a viewing distance 604B. In another example, the HMD 200 may move closer with respect to the eye or the eye-pupil as shown in FIG. 6E, and the sensor pack 236 and/or other sensors coupled to the wearable computing system may be configured to provide information relating to a change in the viewing distance to a viewing distance 604C.

At block 306, the method 300 includes receiving gaze information relating to a gaze axis from an eye-tracking system. The eye-tracking system may be coupled to the wearable computing system and may be in communication with the computing device. The computing device may be configured to receive gaze information relating to the gaze axis from the eye-tracking system. The eye-tracking system may, for instance, include a camera (e.g., an infrared camera) that may capture images of one or both of eyes of a wearer of the HMD 200 and may be configured to deliver image information to the computing device, which may accordingly make a determination regarding the gaze axis. Other known means and methods of eye-tracking to determine the gaze axis may include use of visible light illumination and/or various imaging techniques.

In some examples, the HMD 200 may move with respect to the gaze axis while the gaze axis may remain fixed. In other examples, the HMD 200 may remain fixed and the gaze axis may move. In yet other examples, both the HMD 200 and the gaze axis may move. The sensor pack 236 and the eye-tracking system may be configured to continuously provide to the computing device information relating to relative position of the HMD 200 with respect to the gaze axis and rate of motion of the HMD 200 and the gaze axis with respect to each other.

At block 308, the method 300 includes adjusting the given location of the displayed content in the display area. Based on the movement information and the gaze information received at the computing device from the sensor pack 236 and the eye-tracking system and/or other sensors coupled to the wearable computing system, the computing device may be configured to adjust the given location of the displayed content so as to maintain a location of the displayed content with respect to the gaze axis. The displayed content may thus appear fixed or stable with respect to the gaze axis.

In some examples, the computing device may be configured to adjust the given location of the displayed content by applying a transform to the displayed content to compensate for motion of the HMD 200 and/or the gaze axis with respect to each other. The transform may, for example, include an offset of the displayed content in the display area of the HMD 200 to compensate for a shift in the HMD 200 with respect to the gaze axis. In FIG. 4C, a shifted displayed content 402C is shown as an example. The given location of the displayed content may be adjusted downward as illustrated by the shifted displayed content 402C to compensate for a shift upward of the HMD 200 and maintain the given location of the displayed content with respect to the gaze axis such that the displayed content may appear fixed and stable with respect to the gaze axis. Offsetting the displayed content may be based on relative position of the HMD 200 with respect to the gaze axis and/or based on rate of motion of the HMD 200 with respect to the gaze axis (e.g., linear speed and linear acceleration).

The transform may also comprise a rotational adjustment to the given location of the displayed content to compensate for a rotation of the HMD 200 with respect to the gaze axis. In FIG. 5C, a rotated displayed content 502C is shown as an example. The given location of the displayed content may be adjusted by rotating the displayed content clockwise as illustrated by the rotated displayed content 502C to compensate for a counter-clockwise motion of the HMD 200 and maintain the given location and orientation of the displayed content with respect to the gaze axis such that the displayed content may appear fixed and stable with respect to the gaze axis. Rotating the displayed content may be based on relative position of the HMD 200 with respect to the gaze axis and/or based on rate of motion of the HMD 200 with respect to the gaze axis (e.g., rotational speed and rotational acceleration).

The transform may also comprise a scale factor to compensate for a change in the viewing distance. For example, the HMD 200 may move farther from the eye as shown in FIG. 6C, and the transform may scale up (e.g., enlarge) the displayed content as shown by an enlarged displayed content 602B in FIG. 6D to compensate for the HMD 200 moving farther from the eye as illustrated by the viewing distance 604B as compared to the viewing distance 604A. As a result of applying the scale factor to the displayed content, the displayed content may appear fixed and stable with respect to the eye. The scale factor may be based on a change in the viewing distance and/or a rate of change of the viewing distance (e.g., speed and acceleration of motion of the HMD 200 farther or closer to the eye or eye pupil). In another example, the HMD 200 may move closer to the eye or the eye pupil and the displayed content may be scaled down (e.g., made smaller) as shown by a smaller displayed content 602C to compensate for the HMD 200 moving closer to the eye as illustrated by the viewing distance 604C as compared to the viewing distance 604A.

Adjustments illustrated in FIGS. 4, 5 and 6 are for illustrations only. Other adjustments or combination of adjustments (e.g., a transform that may include a combination of an offset, a rotational adjustment, and a scale factor) are possible. In describing the method 300, references to the HMD 200 moving relative to or with respect to the gaze axis may be equivalent to the gaze axis moving with respect to the HMD 200. The transform applied to the displayed content may utilize information relating to relative motion of the HMD 200 with respect the gaze axis or a reference point, which may be equivalent to relative motion of the gaze axis or the reference point with respect to the HMD 200.

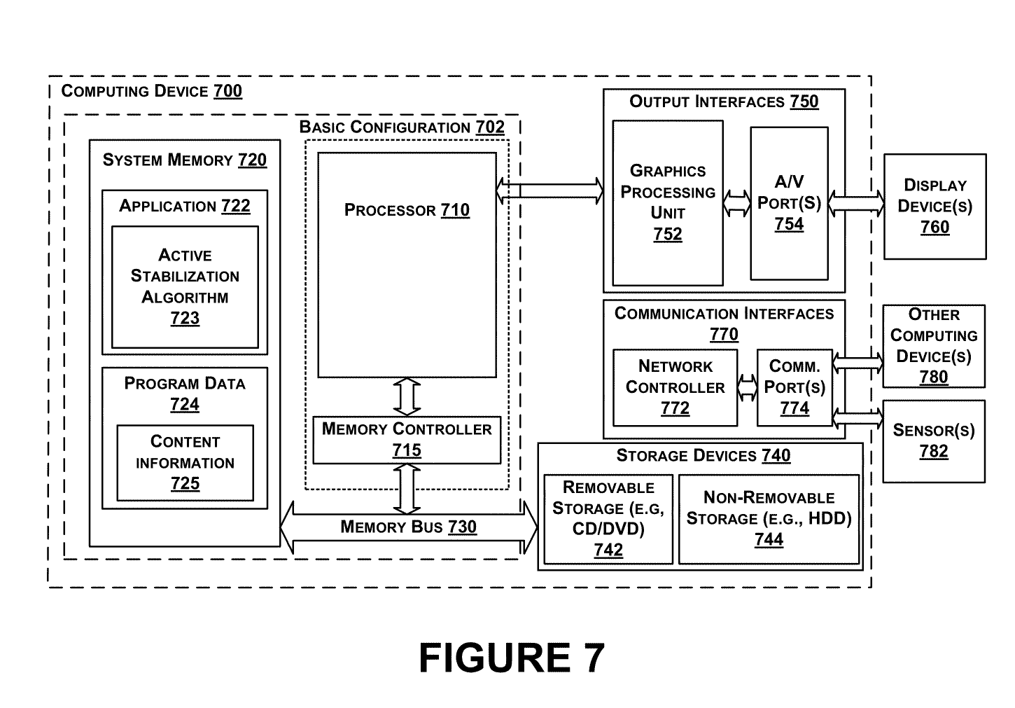

FIG. 7 is a functional block diagram illustrating an example computing device 700 used in a computing system that is arranged in accordance with at least some embodiments described herein. The computing device 700 may be a personal computer, mobile device, cellular phone, video game system, or global positioning system, and may be implemented as a client device, a server, a system, a combination thereof, or may be part of the wearable computing system 100 shown in FIG. 1, or part of an HMD (e.g., as shown in FIGS. 2A-2B). Alternatively, the computing device 700 may be communicatively coupled to an HMD via a wired or wireless connection.

In a basic configuration 702, computing device 700 may include one or more processors 710 and system memory 720. A memory bus 730 can be used for communicating between the processor 710 and the system memory 720. Depending on the desired configuration, processor 710 can be of any type including but not limited to a microprocessor (μP), a microcontroller (μC), a digital signal processor (DSP), or any combination thereof. A memory controller 715 can also be used with the processor 710, or in some implementations, the memory controller 715 can be an internal part of the processor 710.

Depending on the desired configuration, the system memory 720 can be of any type including but not limited to volatile memory (such as RAM), non-volatile memory (such as ROM, flash memory, etc.) or any combination thereof. System memory 720 may include one or more applications 722, and program data 724. Application 722 may include active stabilization algorithm 723, in accordance with the present disclosure. Program Data 724 may include content information 725 that could be directed to any number of types of data. In some example embodiments, application 722 can be arranged to operate with program data 724 on an operating system.

Computing device 700 can have additional features or functionality, and additional interfaces to facilitate communications between the basic configuration 702 and other devices or components. For example, data storage devices 740 can be provided including removable storage devices 742, non-removable storage devices 744, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Computer storage media can include volatile and nonvolatile, non-transitory, removable and non-removable media implemented in any method or technology for storage of information, such as computer readable instructions, data structures, program modules, or other data.

System memory 720 and storage devices 740 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 700. Any such computer storage media can be part of device 700.

Computing device 700 can also include output interfaces 750 that may include a graphics processing unit 752, which can be configured to communicate to various external devices such as display devices 760 or speakers via one or more A/V ports 754 or a communication interface 770. The communication interface 770 may include a network controller 772, which can be arranged to facilitate communications with one or more other computing devices 780 and one or more sensors 782 over a network communication via one or more communication ports 774. The one or more sensors 782 are shown external to the computing device 700, but may also be internal to the device. The communication connection is one example of a communication media. Communication media may be embodied by computer readable instructions, data structures, program modules, or other data in a modulated data signal, such as a carrier wave or other transport mechanism, and includes any information delivery media. A modulated data signal can be a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared (IR) and other wireless media.

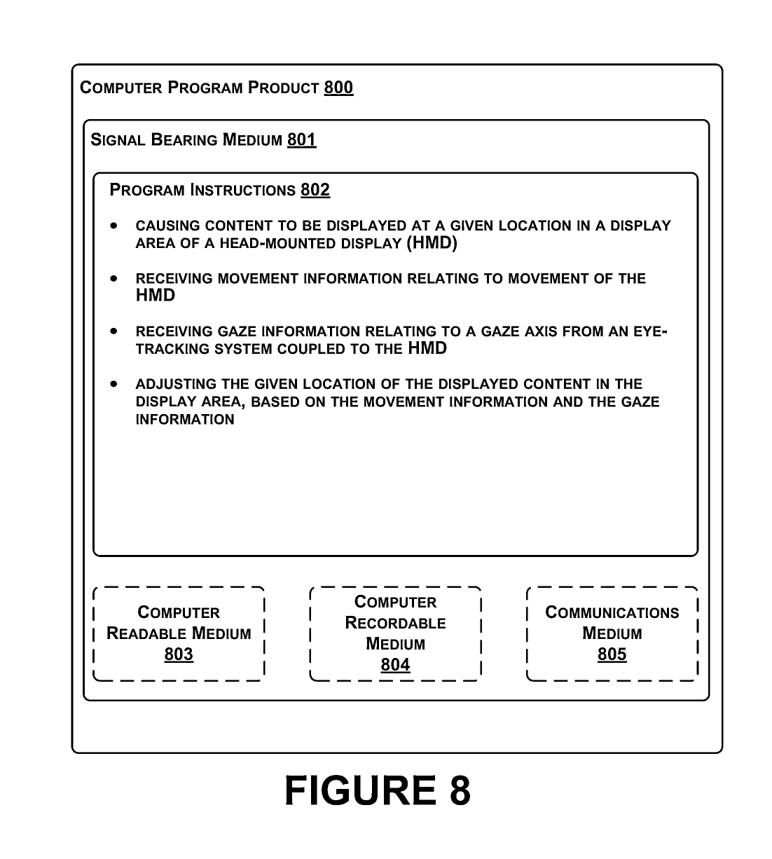

In some embodiments, the disclosed methods may be implemented as computer program instructions encoded on a computer-readable storage media in a machine-readable format, or on other non-transitory media or articles of manufacture. FIG. 8 is a schematic illustrating a conceptual partial view of an example computer program product 800 that includes a computer program for executing a computer process on a computing device, arranged according to at least some embodiments presented herein. In one embodiment, the example computer program product 800 is provided using a signal bearing medium 801. The signal bearing medium 801 may include one or more program instructions 802 that, when executed by one or more processors may provide functionality or portions of the functionality described above with respect to FIGS. 1-7. Thus, for example, referring to the embodiments shown in FIG. 3, one or more features of blocks 302-308 may be undertaken by one or more instructions associated with the signal bearing medium 801. In addition, the program instructions 802 in FIG. 8 describe example instructions as well.

In some examples, the signal bearing medium 801 may encompass a computer-readable medium 803, such as, but not limited to, a hard disk drive, a Compact Disc (CD), a Digital Video Disk (DVD), a digital tape, memory, etc. In some implementations, the signal bearing medium 801 may encompass a computer recordable medium 804, such as, but not limited to, memory, read/write (R/W) CDs, R/W DVDs, etc. In some implementations, the signal bearing medium 801 may encompass a communications medium 805, such as, but not limited to, a digital and/or an analog communication medium (e.g., a fiber optic cable, a waveguide, a wired communications link, a wireless communication link, etc.). Thus, for example, the signal bearing medium 801 may be conveyed by a wireless form of the communications medium 805 (e.g., a wireless communications medium conforming with the IEEE 802.11 standard or other transmission protocol).

The one or more programming instructions 802 may be, for example, computer executable and/or logic implemented instructions. In some examples, a computing device such as the computing device 700 of FIG. 7 may be configured to provide various operations, functions, or actions in response to the programming instructions 802 conveyed to the computing device 700 by one or more of the computer readable medium 803, the computer recordable medium 804, and/or the communications medium 805. It should be understood that arrangements described herein are for purposes of example only. As such, those skilled in the art will appreciate that other arrangements and other elements (e.g. machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims, along with the full scope of equivalents to which such claims are entitled. It is also to be understood that the terminology used herein is for the purpose of describing particular embodiments only, and is not intended to be limiting.

1. A method, comprising:
causing content to be displayed at a first location within a display area of a head-mounted display (HMD);
receiving movement information relating to movement of the HMD;
receiving gaze information relating to a gaze axis from an eye-tracking system coupled to the HMD, wherein the movement information and the gaze information indicate relative motion of the HMD with respect to the gaze axis; and
adjusting a location of the displayed content from the first location to a second location within the display area, based on the relative motion of the HMD with respect to the gaze axis.

2. The method of claim 1, wherein adjusting the location of the displayed content from the first location to the second location comprises applying a transform to the displayed content.

3. The method of claim 2, wherein the transform comprises an offset associated with a shift of the HMD with respect to the gaze axis.

4. The method of claim 2, wherein the transform comprises a rotational adjustment associated with a rotation of the HMD with respect to the gaze axis.

5. The method of claim 2, wherein the transform comprises a scale factor associated with a change in a viewing distance.

6. The method of claim 2, wherein the transform includes one or more of: (i) an offset based on a speed of the movement of the HMD, (ii) a rotational adjustment based on a rotational speed of the movement of HMD with respect to the gaze axis, and (iii) a scale factor based on a rate of change in a viewing distance.

7. The method of claim 1, wherein the eye-tracking system comprises at least one sensor configured to provide the gaze information.

8. The method of claim 1, wherein the movement information includes information relating to a relative position of the HMD with respect to the gaze axis.

9. The method of claim 1, wherein the movement information includes information associated with one or more of (i) speed, and (ii) acceleration of the movement of the HMD.

10. The method of claim 1, wherein adjusting the location of the displayed content from the first location to the second location comprises causing the displayed content to be stable with respect to the gaze axis.

11. A non-transitory computer readable memory having stored thereon instructions executable by a computing device to cause the computing device to perform functions comprising:
receiving information relating to a first position of a head-mounted display (HMD) coupled to a wearable computing system;
receiving, from an eye-tracking system coupled to the wearable computing system, gaze information relating to a gaze axis;
causing content to be displayed at a first location within a display area of the HMD, based on a first relative position of the HMD with respect to the gaze axis of the eye;
receiving information relating to a movement of the HMD to a second relative position with respect to the gaze axis; and
adjusting a location of the displayed content from the first location to a second location within the display area, based on the second relative position of the HMD with respect to the gaze axis.

12. The non-transitory computer readable memory of claim 11, wherein the function of adjusting the location of the displayed content from the first location to the second location within the display area comprises applying a transform to the displayed content, wherein the transform includes one or more of: (i) an offset associated with a shift of the HMD with respect to the gaze axis, (ii) a rotational adjustment associated with a rotation of the HMD with respect to the gaze axis, and (iii) a scale factor associated with a change in a viewing distance.

13. The non-transitory computer readable memory of claim 11, wherein the function of adjusting the location of the displayed content from the first location to the second location within the display area comprises adjusting the location based on a rate of motion of the HMD from the first position to the second position.

14. The non-transitory computer readable memory of claim 11, wherein the function of adjusting the location of the displayed content from the first location to the second location comprises stabilizing the displayed content with respect to the gaze axis.

15. A system, comprising:
a head-mounted display (HMD);
an eye-tracking system, wherein the eye-tracking system is configured to provide gaze information relating to a gaze axis; and
a computing device in communication with the HMD and the eye-tracking system, wherein the computing device is configured to:
cause content to be displayed at a first location within a display area of the HMD;
receive movement information relating to movement of the HMD;
receive the gaze information relating to the gaze axis from the eye-tracking system, wherein the movement information and the gaze information indicate relative motion of the HMD with respect to the gaze axis; and
adjust a location of the displayed content from the first location to a second location within the display area, based on the relative motion of the HMD with respect to the gaze axis.

16. The system of claim 15, further comprising a sensor coupled to the computing device, wherein the computing device is configured to receive the movement information from the sensor.

17. The system of claim 15, wherein the computing device is configured to adjust the location of the displayed content from the first location to the second location within the display area by applying a transform to the displayed content, wherein the transform includes one or more of: (i) an offset associated with a shift of the HMD with respect to the gaze axis, (ii) a rotational adjustment associated with a rotation of the HMD with respect to the gaze axis, and (iii) a scale factor associated with a change in a viewing distance.

18. The system of claim 15, further comprising a sensor coupled to the computing device, wherein the computing device is configured to receive the movement information from the sensor including one or more of (i) rotational speed, and (ii) rotational acceleration associated with the movement of the HMD.

19. The system of claim 15, wherein the computing device is further configured to cause the displayed content to be fixed relative to the gaze axis despite the relative motion of the HMD with respect to the gaze axis.

20. The system of claim 15, wherein the eye-tracking system comprises a camera, and wherein the computing device is configured to determine the gaze axis based on one or more images captured by the camera.
